(19) United States
(12) Patent Application Publication
(10) Pub. No.: US 2025/0272718 A1
(43) Pub. Date: Aug. 28, 2025

(54) MOBILE ADVERTISING WITH INTERACTION BETWEEN USERS AND VEHICLES

(71) Applicant: QUALCOMM Incorporated, San Diego, CA (US)

(72) Inventors: Varun Amar REDDY, San Diego, CA (US); Sony AKKARAKARAN, Poway, CA (US)

(21) Appl. No.: 18/589,304

(22) Filed: Feb. 27, 2024

(51) Int. Cl. G06Q 30/0251; G06F 3/01

(52) U.S. Cl. CPC G06Q 30/0271; G06F 3/017; G06Q 30/0261

(57) ABSTRACT

Aspects presented herein may enable interactions between advertisements and users based on relative positioning measurements and gesture recognition of the users. In one aspect, a UE detects at least one of a relative location or a relative orientation of at least one target with respect to the UE. The UE outputs, via at least one display associated with the UE, at least one message in a set of messages based on the detected relative location or the detected relative orientation of the at least one target. The UE obtains, from the at least one target or a device associated with the at least one target, an indication to interact with the at least one message. The UE performs, based on the indication, at least one of a modification of the at least one message or a transmission of a response for the device associated with the at least one target.

### TECHNICAL FIELD

The present disclosure relates generally to communication systems, and more particularly, to wireless communication involving mobile advertising.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus detects at least one of a relative location or a relative orientation of at least one target with respect to a user equipment (UE). The apparatus outputs, via at least one display associated with the UE, at least one message in a set of messages based on the detected relative location or the detected relative orientation of the at least one target. The apparatus obtains, from the at least one target or a device associated with the at least one target, an indication to interact with the at least one message. The apparatus performs, based on the indication, at least one of a modification of the at least one message or a transmission of a response for the device associated with the at least one target.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of camera-aided positioning in accordance with various aspects of the present disclosure.

FIG. 6 is a diagram illustrating an example of displaying an advertisement on one or more displays of an advertisement vehicle based on relative positioning measurements of a target user in accordance with various aspects of the present disclosure.

FIG. 7A is a diagram illustrating an example of displaying and adapting an advertisement based on relative positioning measurements and user interaction in accordance with various aspects of the present disclosure.

FIG. 7B is a diagram illustrating an example of displaying and adapting an advertisement based on relative positioning measurements and user interaction in accordance with various aspects of the present disclosure.

FIG. 8 is a diagram illustrating an example of an advertisement vehicle providing navigation information based on a request from a user in accordance with various aspects of the present disclosure.

FIG. 9 is a diagram illustrating an example of an advertisement vehicle modifying its advertisement and/or display setting(s) based on velocity in accordance with various aspects of the present disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

### DETAILED DESCRIPTION

Aspects presented herein may improve the overall effectiveness and user experience of mobile advertising. Aspects presented herein may enable mobile advertising to become more personalized and engaging to surrounding people based on using location information and associated positioning measurements. For example, in one aspect of the presented disclosure, an advertisement vehicle may be configured to enable interactions between the displayed advertisements and users based on relative positioning measurements and gesture recognition. In another aspect of the present disclosure, the advertisement vehicle may also be configured to display and/or disable the interactive advertisements based on a set of safety criteria for ensuring the safety of drivers and users passing by.

In some implementations, a vehicle displaying an advertisement is configured to allow a user to interact with the advertisement based on a location of the user relative to the vehicle. The interaction can be gesture detected by sensors on the vehicle, or via a user input device associated with the user. The user input device can include a smartphone associated with the user or a display of a second vehicle in which the user is located. In some implementations, the vehicle is configured to adapt or modify the advertisement based on input from the user. In some implementations, the vehicle is configured to disable the interaction between the user and the advertisement based on one or more safety conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

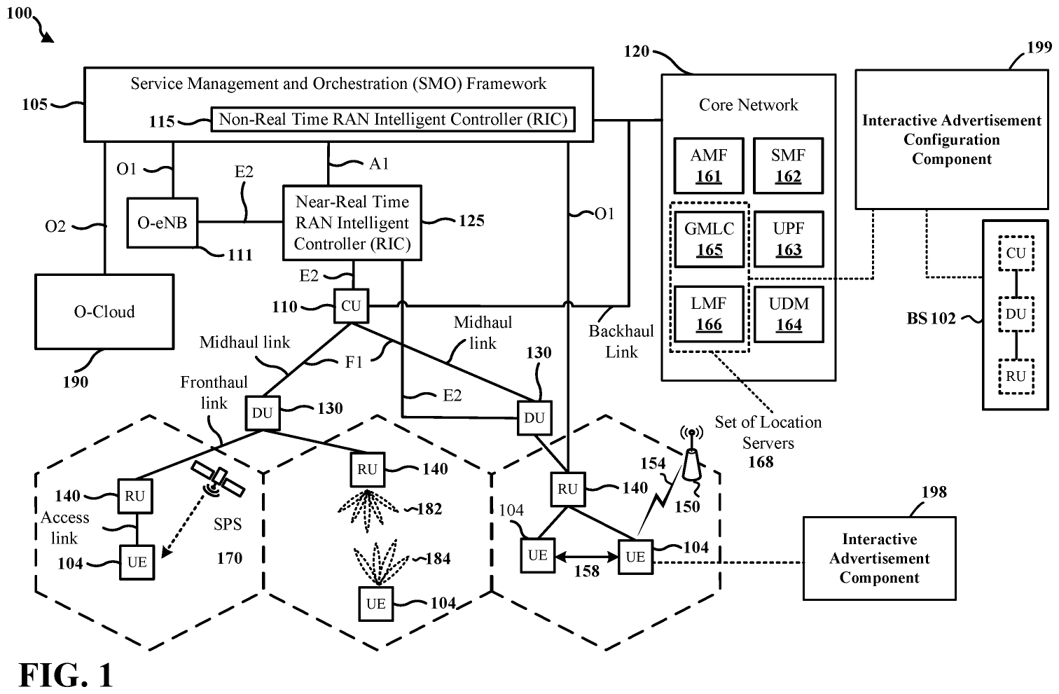

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an interactive advertisement component 198 that may be configured to detect at least one of a relative location or a relative orientation of at least one target with respect to the UE; output, via at least one display associated with the UE, at least one message in a set of messages based on the detected relative location or the detected relative orientation of the at least one target; obtain, from the at least one target or a device associated with the at least one target, an indication to interact with the at least one message; and perform, based on the indication, at least one of a modification of the at least one message or a transmission of a response for the device associated with the at least one target. In certain aspects, the base station 102 or the one or more location servers 168 may have an interactive advertisement configuration component 199 that may be configured to provide interactive advertisement configurations for the UE 104.

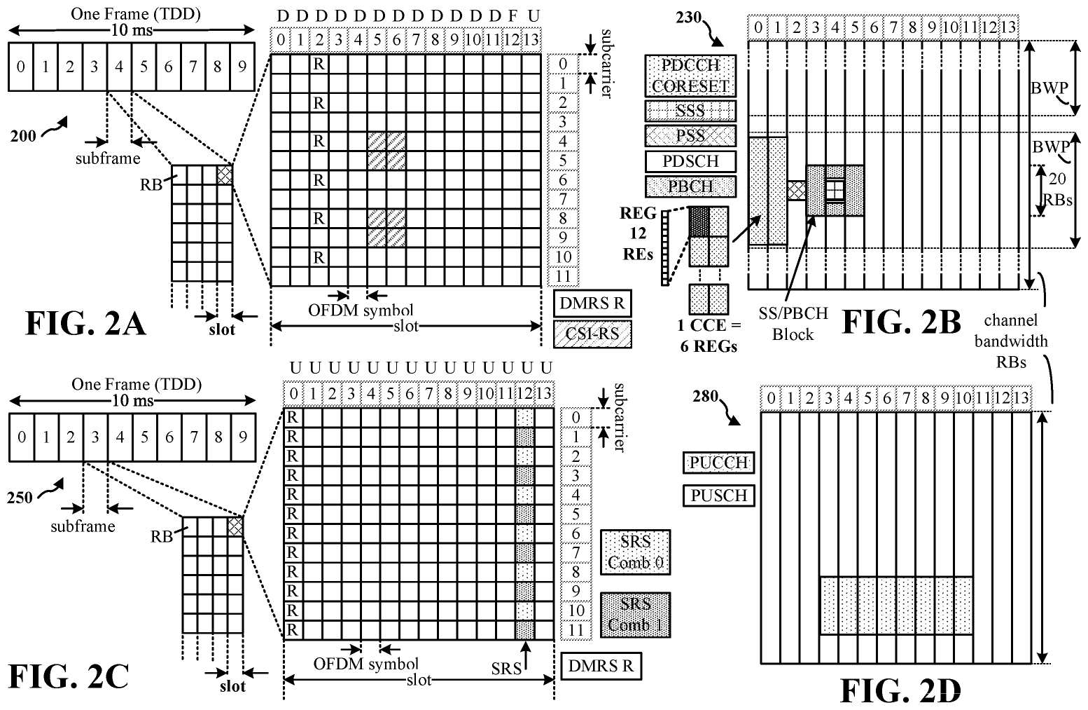

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

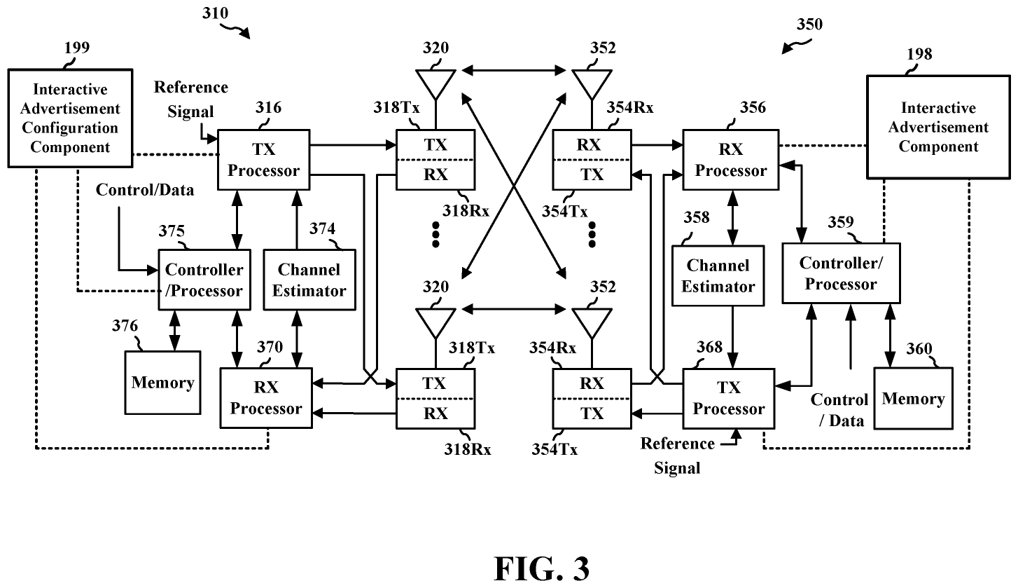

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the interactive advertisement component 198 of FIG. 1.

At least one of the TX processor 316, the RX processor 370, and the controller/processor 375 may be configured to perform aspects in connection with the interactive advertisement configuration component 199 of FIG. 1.

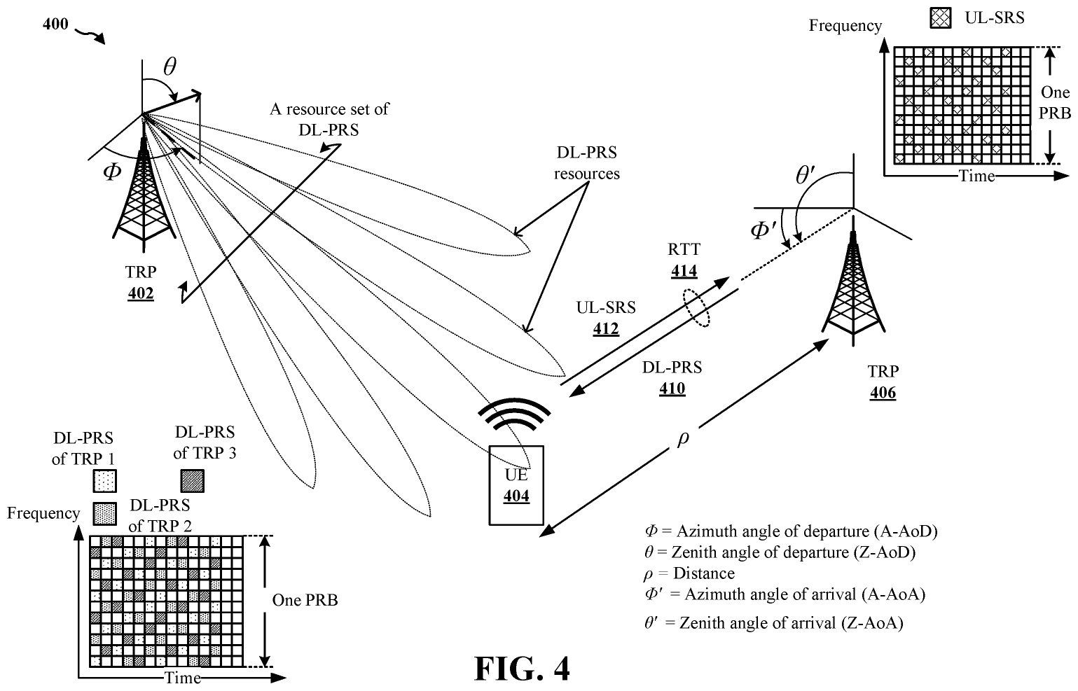

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., IT_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, tracking reference signal (TRS), phase tracking reference signal (PTRS), cell specific reference signal/cell reference signal (CRS), CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to Global Navigation Satellite Systems (GNSS)-based positioning (e.g., positioning based on reception of signals from satellites) and network-based positioning (e.g., as described in connection with FIG. 4), camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in view of the at least one camera, etc.). For example, images captured by the dashboard camera (dash cam) of a vehicle may be used for calculating the three-dimensional (3D) position and/or 3D orientation of the vehicle while the vehicle is moving. Similarly, images captured by the camera of a mobile device may be used for estimating the location of the mobile device user or the location of one or more objects in the images. In another example, a camera (or a UE equipped with the camera) may determine its position by matching object(s) in images captured by the camera with object(s) in a map (e.g., a high-definition (HD) map), such as specified buildings, landmarks, etc. In some implementations, camera-based positioning may provide centimeter-level and 6-degrees-of-freedom (6DOF) positioning. 6DOF may refer to a representation of how an object moves through 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning has great potential for various applications, especially in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.), which may be referred to as “vision-aided positioning,” “camera-aided positioning,” “camera-aided location,” and/or “camera-aided perception,” etc. For example, while GNSS and/or inertial measurement unit (IMU) may provide good positioning/localization performance, when GNSS measurement outage occurs, the overall positioning performance might degrade due to IMU bias drifting. Thus, images captured by the camera may provide valuable information to reduce errors. For purposes of the present disclosure, a positioning session (e.g., a period of time in which one or more entities are configured to determine the position of a UE) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

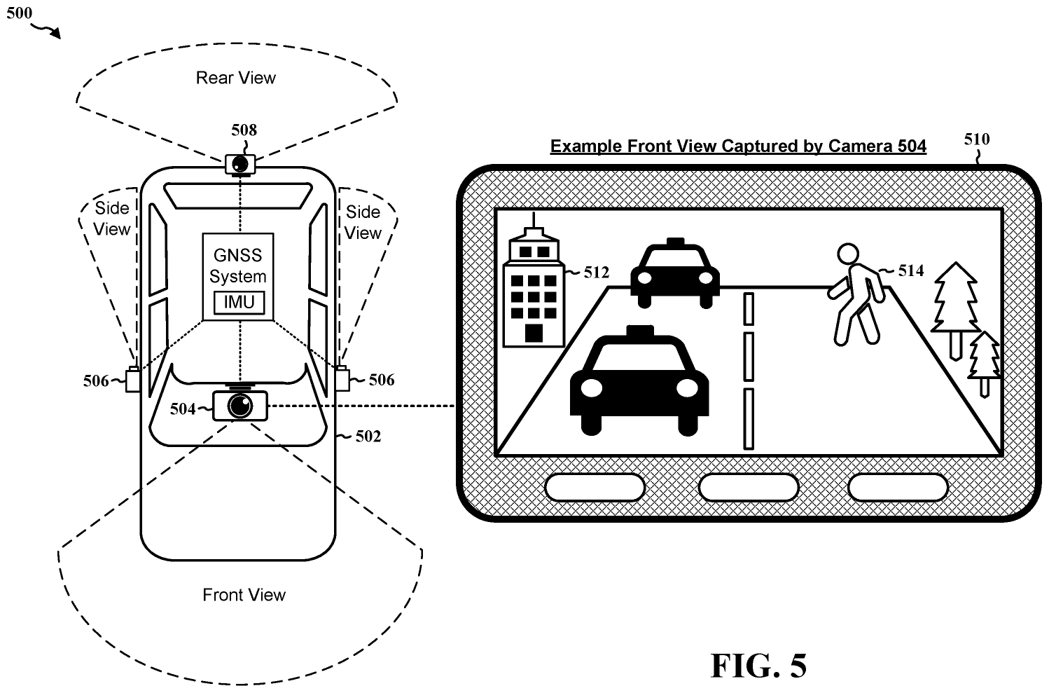

FIG. 5 is a diagram 500 illustrating an example of camera-aided positioning in accordance with various aspects of the present disclosure. A vehicle 502 may be equipped with a GNSS system and a set of cameras, which may include a front camera 504 (for capturing the front view of the vehicle 502), side cameras 506 (for capturing the side views of the vehicle 502), and/or a rear camera 508 (for capturing the rear view of the vehicle 502), etc. In some examples, the GNSS system may further include or be associated with at least one IMU (e.g., a GNSS+IMU system). While FIG. 5 uses the vehicle 502 as an example, it is merely for illustration purposes. Aspects presented herein may also apply to other types of transportations (e.g., motorcycles, bicycles, buses, trains, etc.), devices (e.g., UEs on pedestrians), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera) to assist the positioning may be referred to as a sensor fusion positioning.

The GNSS system may estimate the location of the vehicle 502 based on receiving GNSS signals transmitted from multiple satellites (e.g., based on performing GNSS-based positioning). However, when the GNSS signals are not available or weak, such as when the vehicle 502 is in an urban area or in a tunnel, the estimated location of the vehicle 502 may become inaccurate. Thus, in some implementations, the set of cameras on the vehicle 502 may be used for assisting the positioning, such as for verifying whether the location estimated by the GNSS system based on the GNSS signals is accurate. For example, as shown at 510, images captured by the front camera 504 of the vehicle 502 may include/identify a specific building 512 (which may also be referred to as a feature) that is with a known location, and the vehicle 502 (or the GNSS system or a positioning engine associated with the vehicle 502) may determine/verify whether the location (e.g., the longitude and latitude coordinates) estimated by the GNSS system is in proximity to the known location of this specific building 512. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU).

In some example, a camera may also be used for determining the location (e.g., an absolute location, a relative location, etc.) of one or more objects in the field of view (FOV) of the camera. For example, as shown at 510, the front camera 504 or a UE/system associated with the front camera 504 may determine a relative location between the vehicle 502 and a pedestrian 514 and/or an absolute location of the pedestrian 514 (e.g., if the location of the vehicle 502 is known) based on the image captured by the front camera 504.

Advertising has been a continuously growing industry, where a variety of latest technologies has been used to make advertisements (ads) more personalized, widespread, and/or engaging to users. For example, some vendors have utilized the concept of mobile advertising by displaying advertisement(s) on vehicle (which may be referred to as “advertisement vehicle” hereafter for purposes of the disclosure), where these advertisement vehicles may be configured to simply display a fixed set of advertisements without much dependence on specific criteria. The display(s) on advertisement vehicles may include liquid crystal display (LCD)/light emitting diode (LED) displays, automotive smart glass, and/or a more economical solution such as electronic paper (e-paper) (e.g., similar to what is used in electronic shelf label displays). An automotive smart glass (or simply smart glass) may refer to a type of glass (or a film on glass) that is capable of being switched to become a display, such that visual contents may be shown/displayed on the glass. The smart glass may be configured to remain transparent, partially transparent, or non-transparent while the contents are displayed. For purposes of the present disclosure, mobile advertising may refer to a form of advertising that appears on mobile devices such as smartphones, tablets, and display panels on vehicles using wireless connections. A vehicle may refer to a machine, typically with wheels and an engine, used for transporting people or goods, especially on land.

Aspects presented herein may improve the overall effectiveness and user experience of mobile advertising. Aspects presented herein may enable mobile advertising to become more personalized and engaging to surrounding people based on using location information and associated positioning measurements. For example, in one aspect of the presented disclosure, an advertisement vehicle may be configured to enable interactions between the displayed advertisements and users based on relative positioning measurements and gesture recognition. In another aspect of the present disclosure, the advertisement vehicle may also be configured to display and/or disable the interactive advertisements based on a set of safety criteria for ensuring the safety of drivers and users passing by.

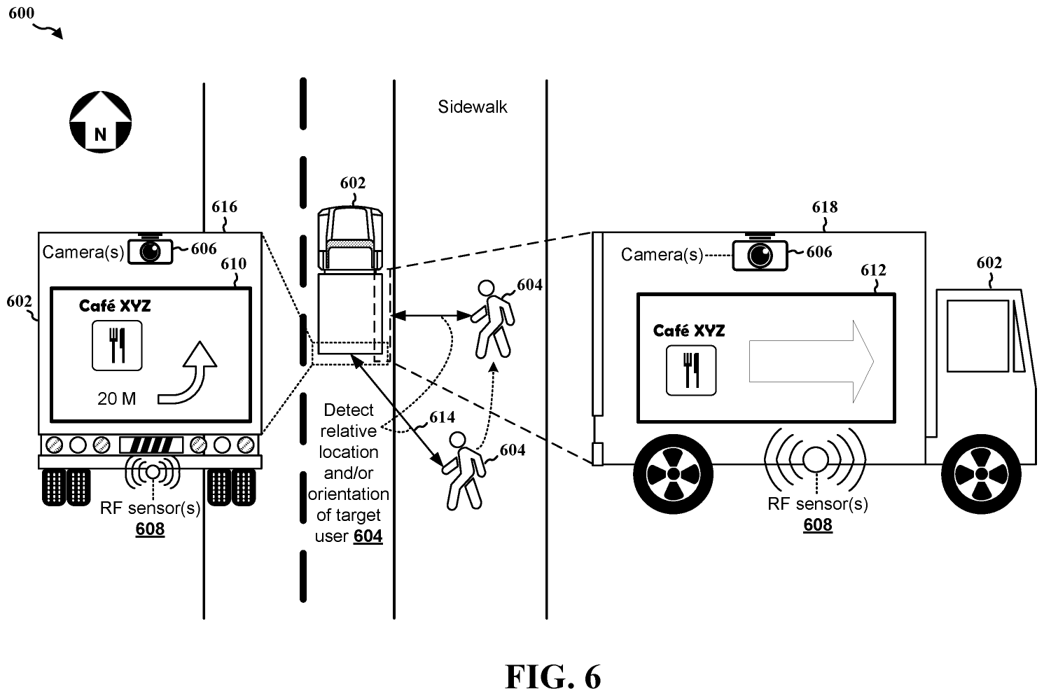

FIG. 6 is a diagram 600 illustrating an example of displaying an advertisement on one or more displays of an advertisement vehicle based on relative positioning measurements of a target user (e.g., a passerby, a pedestrian, etc.) in accordance with various aspects of the present disclosure. While the example here shows an advertisement vehicle displaying an advertisement towards a target user, the target user may also be a cyclist, a driver/occupant of another vehicle, etc.

As shown by the diagram 600, an advertisement vehicle 602 (e.g., which may include an on-board unit (OBU) of the advertisement vehicle 602, a device running an advertisement application, or a display system associated with the advertisement vehicle 602, and collectively be referred to as a UE) may include multiple displays, such as a first display 610 (e.g., on the rear of the advertisement vehicle 602), a second display 612 (on one side/right side of the advertisement vehicle 602), and up to X displays. The displays may be LCD/LED displays, smart glasses, e-papers, or a combination thereof. The owner of the advertisement vehicle 602 may have subscribed to a service (e.g., an advertising service) that allows the playback of (pre-)configured/downloaded advertisements (e.g., images or video) on these displays. In addition, the advertisement vehicle 602 may also include a plurality of sensors that may be used for detecting/identifying location, relative location, and/or relative orientation of one or more objects surrounding the advertisement vehicle 602. For example, the plurality of sensors may include a set of cameras 606 and/or a set of RF sensor(s) 608 (e.g., ultrawideband (UWB) sensor(s), radar(s), light detection and ranging (lidar) sensor(s), or a combination thereof). In some examples, the process of using RF sensor(s) for detecting object(s) (e.g., the presence, the distance, and/or the direction of the object(s), etc.) may be referred to as “sensing,” “sensing measurement,” and/or “RF sensing,” etc.

In one aspect, the advertisement vehicle 602 may be configured to perform positioning or sensing measurements to detect the presence of object(s)/target(s) (e.g., people and other vehicles, etc.) in its vicinity (e.g., within a threshold/defined distance of the advertisement vehicle 602). If presence of object(s) is detected, based on the positioning measurements and/or sensing measurements, the advertisement vehicle 602 may also be able to determine the location of the object(s), and/or the relative location/orientation of the object(s) with respect to the advertisement vehicle 602. Then, the advertisement vehicle 602 may select at least one display to output/show an advertisement or multiple advertisements based on the location, relative location, and/or relative orientation of the object(s), such as displaying the advertisement towards the object(s).

In addition, the advertisement vehicle 602 may also select the advertisement(s) to be displayed based on the location/relative location/relative orientation of the object(s). For example, the advertisement vehicle 602 may be configured to detect the presence of target(s) (e.g., vehicles, cyclists, pedestrians, etc.) around the advertisement vehicle 602 using its sensor(s), such as using the set of cameras 606 and/or the set of RF sensors 608. Then, as shown at 614, the advertisement vehicle 602 may detect that a target user 604 is in its proximity (e.g., within a threshold/defined distance of the advertisement vehicle 602). Based on the detection of the target user 604, the advertisement vehicle 602 may also determine/calculate the location, the relative location, and/or the relative orientation of the target user 604. For example, based on the positioning or sensing measurements from the set of cameras 606 and/or the set of RF sensors 608, the advertisement vehicle 602 may determine that the target user 604 is at the southeast of the advertisement vehicle 602 and approximately X meters away.

Utilizing the (relative) location/orientation information of the target user 604, the advertisement vehicle 602 may select at least one of its displays to show/output one or more advertisements to the target user 604. For example, as shown at 616 and 618, the advertisement vehicle 602 may use the first display 610 and the second display 612 to display an advertisement to the target user 604. In another example, the advertisement vehicle 602 may use the first display 610 to display the advertisement as shown at 616 while the target user 604 is at the rear of the advertisement vehicle 602. When the target user 604 is bypassing the advertisement vehicle 602 from the right, the advertisement vehicle 602 may switch (and resume) displaying the advertisement using the second display 612 as shown at 618. As such, the advertisement vehicle 602 may be configured to continuously track the movement (e.g., direction and orientation) of the target user 604, and display the advertisement using a most suitable display (e.g., the one facing the target user 604 or the one that is best viewed by the target vehicle, etc.) based on the movement of the target user 604. Note while the example in FIG. 6 shows the target user is outside of the advertisement vehicle, it is merely for illustration purposes. The target user may also be within the advertisement vehicle or in another vehicle in some scenarios. For example, the advertisement vehicle may be a bus that is capable of detecting the position and/or the orientation of its occupant(s) within the bus, and selecting a display (from multiple displays) to show an advertisement to an occupant based on the position/orientation of the occupant (e.g., using a display that is closest to the occupant or facing the occupant). In another example, the advertisement vehicle may be able to pair, communicate, or exchange information with another vehicle, and the advertisement vehicle may be able to obtain occupant information (e.g., location/orientation of the occupant(s), etc.) from the another vehicle.

In some implementations, the advertisement vehicle 602 may be configured to select a set of parameters for displaying advertisement(s) based on the environmental condition(s), the time of the day, feature(s) associated with a target, and/or the location/relative location/the relative orientation of the target. The set of parameters may include the display size for the advertisement(s), an amount of information to be displayed for the advertisement(s), the font size for the advertisement(s), a set of colors to be used for the advertisement(s), a display brightness for the advertisement(s), and/or a display angle for the advertisement(s), etc. For example, the advertisement vehicle 602 may be configured to apply a first color setting/screen brightness during a day time (and/or sunny day), and apply a second color setting/screen brightness during a night time (and/or during rainy day).

In another example, the advertisement vehicle 602 may be configured to apply different settings/parameters for displaying an advertisement based on feature(s) associated with the target user 604. For example, if the target user 604 is detected to be a kid, the advertisement vehicle 602 may be configured to display an advertisement using a bigger font, an easier language, or a setting suitable for a kid (e.g., displaying the advertisement towards a lower angle). Similarly, if the target user 604 is detected to be an adult, the advertisement vehicle 602 may be configured to display an advertisement using a regular font/language or a setting suitable for an adult (e.g., displaying the advertisement at a regular angle).

In some implementations, the advertisement vehicle 602 may also be configured to adjust the displaying settings (e.g., brightness, angle, display size) based on the relative location and/or relative orientation of the target user 604. For example, based on detecting that the target user 604 is closer to the rear of the advertisement vehicle 602, the advertisement vehicle 602 may adjust the display angle and brightness of the display to a setting that is most suitable for viewing from the stand point of the target user 604.

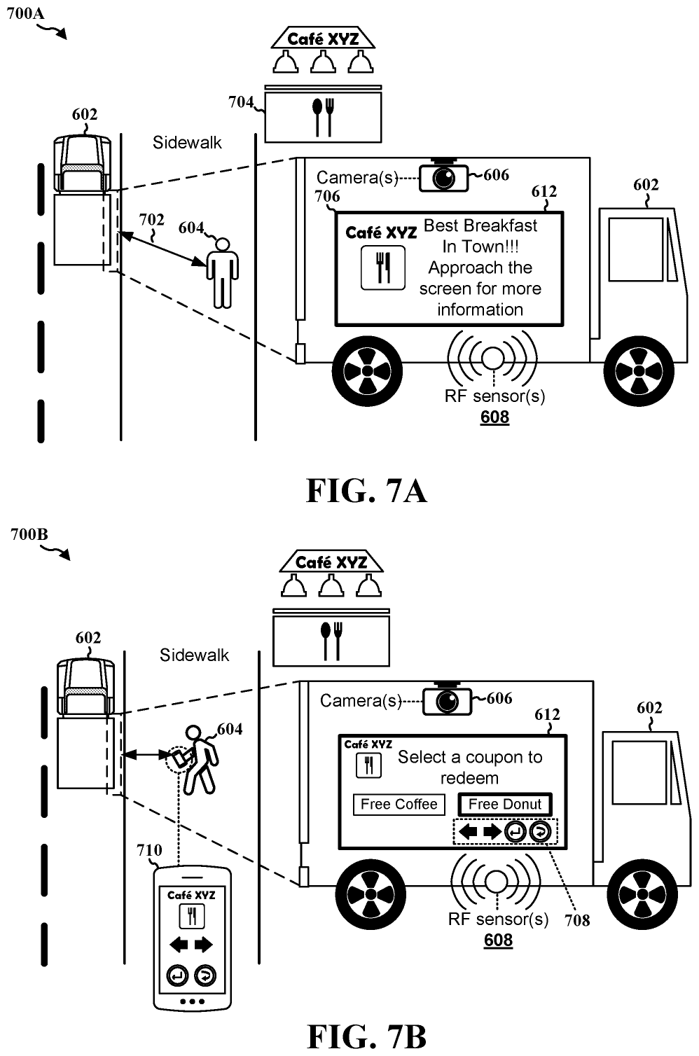

FIGS. 7A and 7B are diagrams 700A and 700B illustrating an example of displaying and adapting an advertisement based on relative positioning measurements and user interaction in accordance with various aspects of the present disclosure. As discussed in connection with FIG. 6, an advertisement vehicle (e.g., the advertisement vehicle 602) may be equipped/fitted with multiple displays (e.g., LCD panels, smart glasses, e-papers, etc.), where the advertisement vehicle may be configured to perform positioning, sensing, and/or visual measurements to detect the presence of people and other vehicles in the vicinity.

In one aspect of the present disclosure, based on the determined presence, the relative location, and/or the relative orientation of a user with respect to an advertisement vehicle, a corresponding display (e.g., a display that is nearest the user or facing the user) may be selected for showing an advertisement. For example, as shown at 702 in FIG. 7A, after the advertisement vehicle 602 detects the presence, the relative location, and/or the relative orientation of the target user 604 with respect to the advertisement vehicle 602, the advertisement vehicle 602 may display an advertisement using the second display 612 that is facing the target user 604. In addition, the advertisement vehicle 602 may also select the content of the advertisement based on the location of the target user 604. For example, as shown at 704 in FIG. 7A, based on the location of the target user 604 (and also based on the time of the day in some implementations), the advertisement may be related to a restaurant (e.g., the Café XYZ) that is in proximity (e.g., within a defined threshold distance) to the target user 604.

In one example, the advertisement vehicle 602 may have the capability to enable the target user 604 to interact with the advertisement vehicle 602, such as requesting for additional information related to the advertisement displayed by the advertisement vehicle 602. For example, as shown at 706 in FIG. 7A, the advertisement may indicate to the target user 604 to approach the advertisement vehicle 602 or the second display 612 for more information. Then, if the advertisement vehicle 602 detects that the target user 604 approaches the advertisement vehicle 602 (e.g., based on using the set of cameras 606 and/or the set of the RF sensors 608, etc.), the advertisement vehicle 602 may display additional information related to the displayed advertisement (e.g., menu and discounts at Café XYZ, etc.).

In another example, as shown at 708 in FIG. 7B, the advertisement vehicle 602 may be configured with virtual buttons (e.g., buttons generated on a touch screen) and/or physical buttons, which may enable the target user 604 to interact with the advertisement displayed by the second display 612 using the virtual/physical buttons. For example, the target user 604 may use the virtual/physical button(s) to request for additional information, to browse the restaurant menu, to select certain promotional items (e.g., coupons, vouchers, etc.), and/or to obtain the location/direction of the restaurant, etc.

In another example, as shown at 710 in FIG. 7B, if the advertisement vehicle 602 has the capability to pair with a device (e.g., a mobile phone) held by the target user 604, such as based on a pairing mechanism (e.g., Bluetooth, Wi-Fi, etc.), the target user 604 may also be able to interact with the advertisement displayed by the second display 612 using the virtual/physical buttons on the target user's device.

In another example, the target user 604 may be able to interact with the advertisement based on gesture recognition, where the gesture of an “outer” user (e.g., a user that is outside of the advertisement vehicle such as the target user 604) may be recognized by sensors and cameras (e.g., the set of cameras 606 and/or the set of RF sensors 608) on the advertisement vehicle 602, and/or the gesture of an “inner” user (a user that is inside of the advertisement vehicle or in another vehicle) may be recognized by sensors and/or cameras located inside the advertisement vehicle or the another vehicle. Then, based on a set of defined/pre-configured gestures, a user (e.g., the target user 604, a user inside the advertisement vehicle, a user inside another vehicle, etc.) may be able to interact with the advertisement displayed by the advertisement vehicle (e.g., using one of its displays). For example, the set of defined/pre-configured gestures may provide that a hand gesture of swiping right means moving to next page or option, and a hand gesture of swiping left means moving to previous page or option, and an OK hand gesture means confirm/select, etc. As such, the user may interact with the advertisement without specifying or using virtual/physical button(s).

In response to the input(s) or request(s) from the user (e.g., via the virtual/physical buttons, based on gesture recognitions, etc.), the advertisement vehicle 602 may adapt its display(s) to show the additional/requested information, or an acknowledgment of the requested information being provided to the device associated with the user. In some implementations, in the case of the advertisement vehicle 602 (or the advertisement displayed by the advertisement vehicle 602) interacting with the user via a device associated with the user, the advertisement vehicle 602 may also be configured to detect and pair with the device associated with the user, such as a smartphone being held by the user, or another vehicle associated with the user (e.g., the user is in an occupant of another vehicle). In addition, the detection and/or the pairing process may be coordinated using a protocol, such as a 4G/5G wireless communication protocol, a sidelink communication protocol, a positioning protocol, etc.

For example, in the scenario where the user is outside of the advertisement vehicle 602 (which may be referred to as an “outer user” for purposes of the present disclosure), the advertisement vehicle 602 may be configured to transmit RF beacons (such as Bluetooth® discovery messages), and a compatible application on a device associated with the outer user (e.g., a smartphone) may be equipped to communicate with the advertisement vehicle 602 (e.g., responding to the RF beacons). In some examples, the advertisement vehicle 602 may be configured to display a quick response (QR) code or a link, and the outer user may scan the QR code or use the link to establish/initiate a connection with the advertisement vehicle 602.

In another example, in the scenario where the user is inside of another vehicle (which may be referred to as an “inner user” for purposes of the present disclosure), the advertisement vehicle 602 may be configured to use vehicle-to-everything (V2X) or sidelink (SL) technology/protocol to exchange information (e.g., transmit/receive message) with the another vehicle. In some examples, the another vehicle may also be connected to the same advertisement server as the advertisement vehicle 602, and the another vehicle may download the requested information directly from this advertisement server.

In some implementations, the detection of the device associated with the user may involve computer vision methods and associated matching of a position obtained using visual measurements with a position obtained using RF measurements (e.g., using camera/vision-based positioning as described in connection with FIG. 5). In some examples, in the scenario where virtual/physical buttons are provided by the advertisement vehicle 602, the advertisement vehicle 602 may be configured to invite outer user(s) to press the button(s), such as providing operating instructions and/or signs. This feature/invitation may be enabled just in scenarios where the advertisement vehicle is parked in a lot or on a curb and not expected to move. This function may also be switched off by the operator of the advertisement vehicle depending on the situation or the implementation.

As described in connection with FIGS. 7A and 7B, a set of gestures may be pre-defined/configured (e.g., a hand wave, a visual pattern using the fingers, and/or grabbing, etc.) and displayed as part of the advertisement for the advertisement vehicle 602. Then, the target user 604 may indicate or request different types of information using different buttons/gestures (or different combination of buttons/gestures).

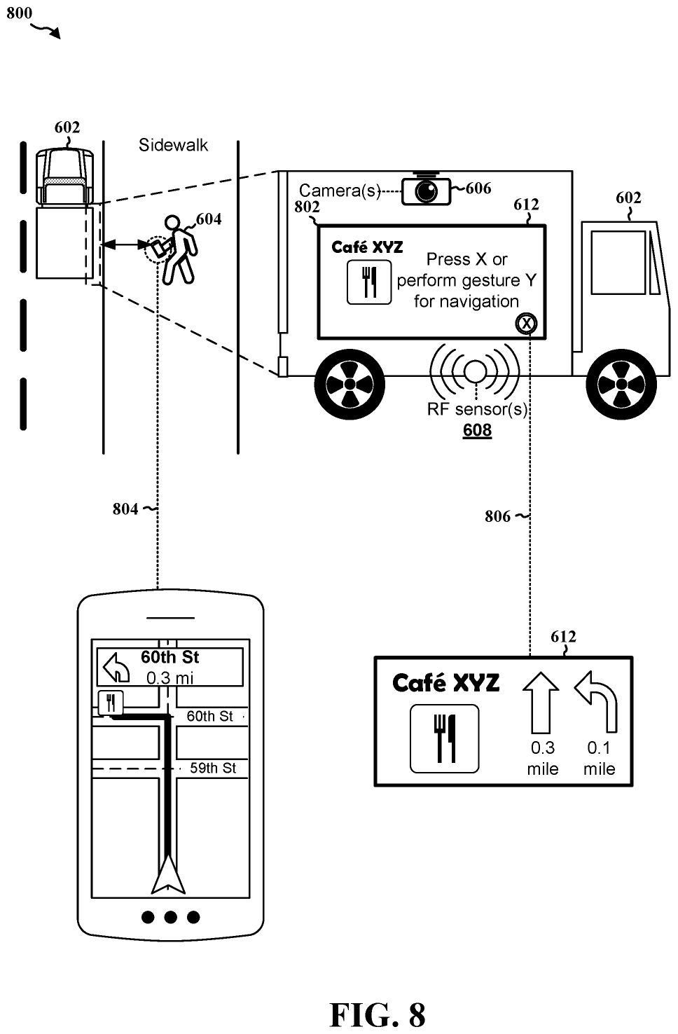

FIG. 8 is a diagram 800 illustrating an example of an advertisement vehicle providing navigation information based on a request from a user in accordance with various aspects of the present disclosure. In some implementations, the advertisement vehicle 602 may include the capability to provide navigation information associated with the displayed advertisement(s) to the target user 604.

For example, as shown at 802, an advertisement displayed by the advertisement vehicle 602 may indicate that navigation information may be provided based on certain inputs (e.g., by pressing a virtual/physical button or perform a specified gesture, etc.). As such, the target user 604 may request the advertisement vehicle 602 for directions to the business associated with the advertisement. In one example, as shown at 804, the advertisement vehicle 602 may transmit the directions to the business to a device associated with the target user 604 (e.g., the smartphone of the target user 604 for the outer user case or another vehicle associated with the target user 604 for the inner user case). Then, the device associated with the target user 604 may guide the target user 604 towards the business. In another example, as shown at 806, in response to the request of the target user 604, the advertisement vehicle 602 may also display the directions to the business via one or more displays.

In some examples, the advertisement vehicle 602 may also provide other/additional information related to the advertisement, such as coupons, registration information, and/or hyperlinks with more details about the advertisement, etc., to the device associated with an inner user (e.g., user in another/second vehicle), where the device may already be paired with the another/second vehicle.

In another aspect of the present disclosure, data analytics may be applied at an advertisement server that provides advertisements to the advertisement vehicle 602. The data analytics may be configured to identify specified advertisements, such as popular advertisements, on the basis of the level of interaction for a given advertisement (e.g., how often additional information was requested by users, by how many different people, etc.). Such specified/popular advertisement may then be displayed more often (or more related promotions/offers may be advertised) and additionally the popularity may be localized to a certain area/region.

In another aspect of the present disclosure, to ensure/improve the safety of drivers and pedestrians or to avoid distracting drivers of other vehicles, an advertisement vehicle may be configured with a set of safety mechanisms.

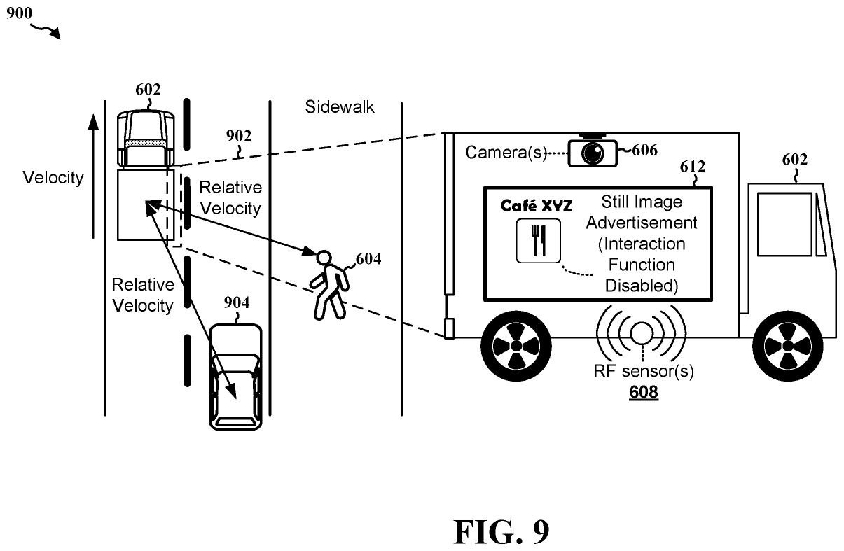

FIG. 9 is a diagram 900 illustrating an example of an advertisement vehicle modifying its advertisement and/or display setting(s) based on velocity in accordance with various aspects of the present disclosure. In one example, as shown at 902, the advertisement vehicle 602 may be configured to display advertisement(s) with static/still image(s) and/or disable the interaction function(s) (e.g., the function that enables the target user 604 to interact with an advertisement) when the advertisement vehicle 602 is moving at a velocity above a velocity threshold, or when the relative velocity between the advertisement vehicle 602 and the target user 604 (including a target user in another vehicle) and/or between the advertisement vehicle 602 and an adjacent vehicle 904 exceeds a relative velocity threshold. Then, if the advertisement vehicle 602 detects that its speed has reduced below the velocity threshold and/or that the relative velocity between the advertisement vehicle 602 and the target user 604/adjacent vehicle 904 has fallen below the relative velocity threshold (or if other vehicles/vehicles within a threshold distance of the advertisement vehicle 602 are detected to be static), the advertisement vehicle 602 may resume displaying the advertisement using a series of images or a video and/or enable the interaction function. Similar configuration/condition may also apply to enabling/disabling interactions between users and the displayed advertisements. In some implementations, the advertisement vehicle 602 may also indicate the enabling/disabling of the interaction function(s) as part of the advertisement (e.g., a visual indication indicating the interaction function being enabled/disabled).

In another example, the advertisement vehicle 602 may be configured to disable or not showing advertisements based on the location of the advertisement vehicle 602. For example, the advertisement vehicle 602 may be configured to display advertisements when it is parked in adjacent to a sidewalk, and not displaying the advertisements when it is travelling on the road or in a designated area (e.g., school zones).

In some implementations, the advertisement vehicle 602 may also be configured to enabling/disabling the interaction functions based on the density of outer users (in certain region(s)). In other words, the density of outer users may serve as a criterion for enabling/disabling interactions. For example, when the advertisement vehicle 602 detects that pedestrians in a region is beyond a density threshold (e.g., the number of pedestrians detected within an area/FOV exceeds a defined number), the advertisement vehicle 602 may be configured to disable gesture-based interactions in the interest of driver safety (e.g., simultaneous gestures from multiple pedestrians may be distracting to drivers). In some examples, the advertisement vehicle 602 may also disable gesture-based interactions for outer users in certain regions with respect to the vehicle. For instance, a pedestrian located in the FOV of the driver of the advertisement vehicle 602 may not be able to use gesture-based interactions. In another example, interaction function(s) for outer users may be disabled when the advertisement vehicle 602 and/or the outer users are located in flagged regions, such as when the outer users are detected to be on crosswalks/crossing the streets, or when the advertisement vehicle 602 is in a school zone (to avoid causing distractions to students/kids), etc.

In some implementations, the advertisement vehicle 602 may also be configured to enable/allow interaction functions for inner users (e.g., occupants in other vehicles) under certain conditions. For example, the advertisement vehicle 602 may enable/allow interaction functions for inner users when the velocity (e.g., the absolute velocity of the advertisement vehicle 602) and/or the relative velocity between the advertisement vehicle 602 and other vehicles are below a velocity threshold and/or a relative velocity threshold. In another example, the advertisement vehicle 602 may enable/allow interaction functions for inner users when the number of virtual/physical button presses within a certain period of time is limited for the inner user. This may avoid causing excessive distractions to the inner users and their drivers. In another example, the advertisement vehicle 602 may enable/allow interaction functions for inner users when the inners users are in vehicles that are in an autonomous/self-driving mode that allows the driver to interact with the advertisement.

Aspects presented herein may improve the overall effectiveness and user experience of mobile advertising. Aspects presented herein may enable mobile advertising to become more personalized and engaging to surrounding people based on using location information and associated positioning measurements. For example, in one aspect of the presented disclosure, an advertisement vehicle may be configured to enable interactions between the displayed advertisements and users based on relative positioning measurements and gesture recognition of the users. In another aspect of the present disclosure, the advertisement vehicle may also be configured to display and/or disable the interactive advertisements based on a set of safety criteria for ensuring the safety of drivers and users passing by.

In some implementations, a vehicle displaying an advertisement is configured to allow a user to interact with the advertisement based on a location of the user relative to the vehicle. The interaction can be gesture detected by sensors on the vehicle, or via a user input device associated with the user. The user input device can include a smartphone associated with the user or a display of a second vehicle in which the user is located. In some implementations, the vehicle is configured to adapt or modify the advertisement based on input from the user. In some implementations, the vehicle is configured to disable the interaction between the user and the advertisement based on one or more safety conditions.

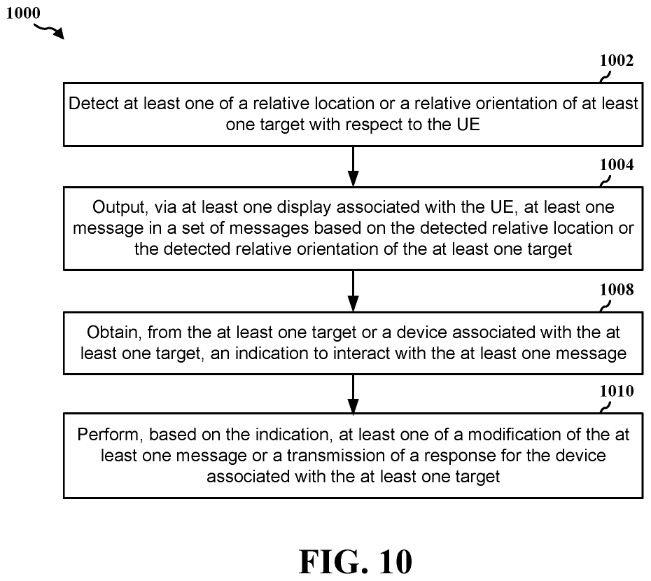

FIG. 10 is a flowchart 1000 of a method of wireless communication at a user equipment (UE). The method may be performed by a UE (e.g., the UE 104, 404; the vehicle 502; the advertisement vehicle 602; the apparatus 1204). The method may configure the UE to enable interactions between displayed advertisements and users based on relative positioning measurements and gesture recognition of the users.

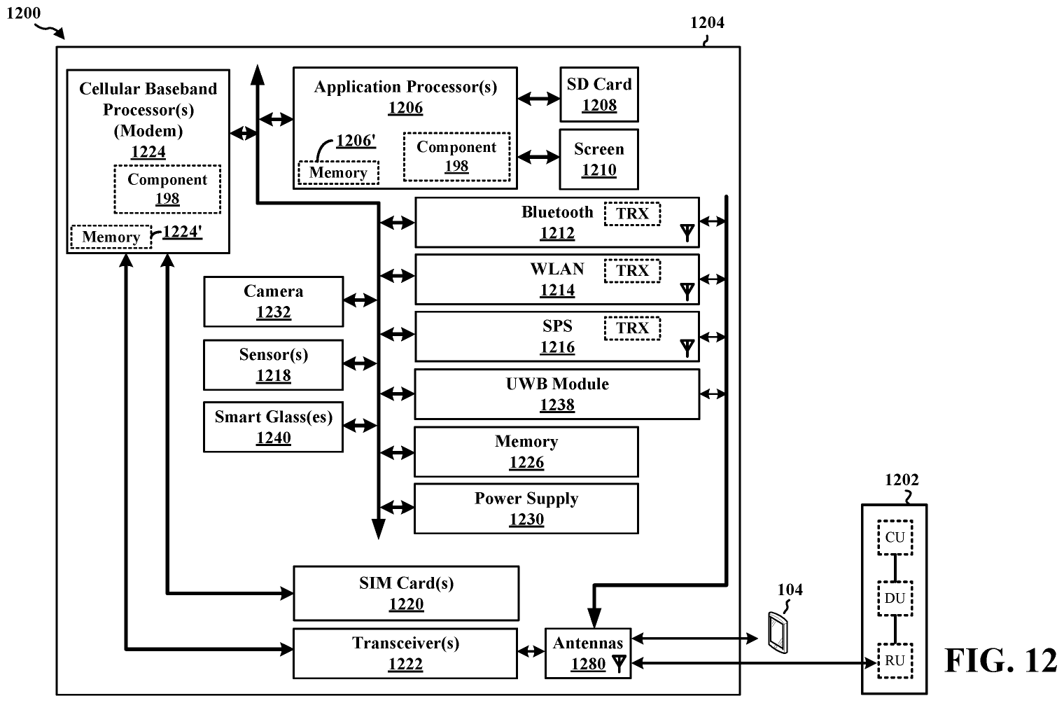

At 1002, the UE may detect at least one of a relative location or a relative orientation of at least one target with respect to the UE, such as described in connection with FIGS. 6, 7A, 7B, 8, and 9. For example, as discussed in connection with 614 of FIG. 6, the advertisement vehicle 602 may detect that a target user 604 is in its proximity (e.g., within a threshold/defined distance of the advertisement vehicle 602). Based on the detection of the target user 604, the advertisement vehicle 602 may also determine/calculate the location, the relative location, and/or the relative orientation of the target user 604. The detection of at least one of the relative location or the relative orientation of at least one target with respect to the UE may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

At 1004, the UE may output, via at least one display associated with the UE, at least one message in a set of messages based on the detected relative location or the detected relative orientation of the at least one target, such as described in connection with FIGS. 6, 7A, 7B, 8, and 9. For example, as discussed in connection with 616 and 618 of FIG. 6, utilizing the (relative) location/orientation information of the target user 604, the advertisement vehicle 602 may select at least one of its displays to show/output one or more advertisements to the target user 604. The output of the at least one message in the set of messages may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, the set of messages may include a set of advertisements, and the at least one message may be at least one advertisement.

At 1008, the UE may obtain, from the at least one target or a device associated with the at least one target, an indication to interact with the at least one message, such as described in connection with FIGS. 7A, 7B, 8, and 9. For example, as discussed in connection with FIGS. 7A and 7B, the advertisement vehicle 602 may have the capability to enable the target user 604 to interact with the advertisement vehicle 602, such as requesting for additional information related to the advertisement displayed by the advertisement vehicle 602. For example, as shown at 706 in FIG. 7A, the advertisement may indicate to the target user 604 to approach the advertisement vehicle 602 or the second display 612 for more information. Then, if the advertisement vehicle 602 detects that the target user 604 approaches the advertisement vehicle 602 (e.g., based on using the set of cameras 606 and/or the set of the RF sensors 608, etc.), the advertisement vehicle 602 may display additional information related to the displayed advertisement (e.g., menu and discounts at Café XYZ, etc.). The obtainment of the indication may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, to obtain, from the at least one target or the device associated with the at least one target, the indication to interact with the at least one message, the UE may be configured to receive a first input from the device associated with the at least one target, receive a second input from one or more components associated with the at least one display, and/or receive a third input based on a gesture performed by the at least one target using at least one sensor or at least one camera. In some implementations, the at least one message may include a set of gestures that can be used for interacting with the at least one message.

In another example, to obtain, from the at least one target, the indication to interact with the at least one message, the UE may be configured to receive, from the at least one target, a request for additional information related to the at least one message. In some implementations, to perform the modification of the at least one message, the UE may be configured to adapt the at least one display to display the addition information requested by the at least one target. In some implementations, to perform the transmission of the response, the UE may be configured to transmit, to the device associated with the at least one target, an acknowledgement of the request.

At 1010, the UE may perform, based on the indication, at least one of a modification of the at least one message or a transmission of a response for the device associated with the at least one target, such as described in connection with FIGS. 7A, 7B, 8, and 9. For example, as discussed in connection with FIGS. 7A and 7B, in response to the input(s) or request(s) from the user (e.g., via the virtual/physical buttons, based on gesture recognitions, etc.), the advertisement vehicle 602 may adapt the display to show the additional/requested information, or an acknowledgment of the requested information being provided to the device associated with the user. The modification of the at least one message or the transmission of the response may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, the UE may detect the device is associated with the at least one target, and pair with the device, such as described in connection with FIGS. 7A, 7B, 8, and 9. For example, as discussed in connection with 710 of FIG. 7B, if the advertisement vehicle 602 has the capability to pair with a device (e.g., a mobile phone) held by the target user 604, such as based on a pairing mechanism (e.g., Bluetooth, Wi-Fi, etc.), the target user 604 may also be able to interact with the advertisement displayed by the second display 612 using the virtual/physical buttons on the target user's device. The detection of the device and/or the pairing of the device may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12. In some implementations, to obtain, from the at least one target, the indication to interact with the at least one message, the UE may be configured to obtain, from the paired device, a set of inputs to interact with the at least one message. In some implementations, to detect the device associated with the at least one target, the UE may be configured to estimate a first position of the at least one target using at least one of a sensor or a camera, estimate a second position of the device based on a set of radio frequency (RF) measurements, and determine that the device is associated with the at least one target based on the estimated first position of the at least one target being within a threshold distance of the second position of the device.

In another example, to obtain the indication to interact with the at least one message, the UE may be configured to obtain a first request for a direction to a business associated with the at least one message, obtain a second request for additional information related to the at least one message, and/or obtain a third request for a coupon related to the at least one message.

In another example, the UE may detect a speed of the UE or a relative velocity between the UE and the at least one target, where to output, via the at least one display associated with the UE, the at least one message, the UE may be configured to display the at least one message using a set of static images if the detected speed of the UE or the relative velocity between the UE and the at least one target is greater than a threshold.

In another example, the UE may detect a number of people within a threshold distance of the at least one target or to the UE, and disable a set of interaction functions if the detected number of people is greater than a threshold, such as described in connection with FIGS. 8, and 9. For example, the advertisement vehicle 602 may also be configured to enabling/disabling the interaction functions based on the density of outer users (in certain region(s)). In other words, the density of outer users may serve as a criterion for enabling/disabling interactions. For example, when the advertisement vehicle 602 detects that pedestrians in a region is beyond a density threshold (e.g., the number of pedestrians detected within an area/FOV exceeds a defined number), the advertisement vehicle 602 may be configured to disable gesture-based interactions in the interest of driver safety (e.g., simultaneous gestures from multiple pedestrians may be distracting to drivers). The detection of the number of people and/or the disablement of the set of interaction functions may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In another example, the UE may disable gesture-based interaction functions based on a set of defined criteria, such as described in connection with FIGS. 8 and 9. For example, the advertisement vehicle 602 may also disable gesture-based interactions for outer users in certain regions with respect to the vehicle. For instance, a pedestrian located in the FOV of the driver of the advertisement vehicle 602 may not be able to use gesture-based interactions. In another example, interaction function(s) for outer users may be disabled when the advertisement vehicle 602 and/or the outer users are located in flagged regions, such as when the outer users are detected to be on crosswalks/crossing the streets, or when the advertisement vehicle 602 is in a school zone (to avoid causing distractions to students/kids), etc. The disablement of the gesture-based interaction functions may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In another example, the UE may select the at least one message in the set of messages based on at least one of the detected relative location or the detected relative orientation of the at least one target.

In another example, the UE may select a set of parameters for outputting the at least one message based on at least one of the detected relative location or the detected relative orientation of the at least one target, where to output the at least one message, the UE may be configured to output the at least one message based on the set of parameters. In some implementations, the set of parameters for displaying the at least one message includes at least one of: a display size for the at least one message, an amount of information to be displayed for the at least one message, a font size for the at least one message, a set of colors to be used for the at least one message, a display brightness for the at least one message, or a display angle for the at least one message. In some implementations, to select the set of parameters for displaying the at least one message based on at least one of the detected relative location or the detected relative orientation of the at least one target, the UE may be configured to select the set of parameters for displaying the at least one message based on at least one of: a distance of the at least one target from the UE, a movement of the at least one target with respect to the UE, a height of the at least one target with respect to the UE, or a motion state associated with the UE.

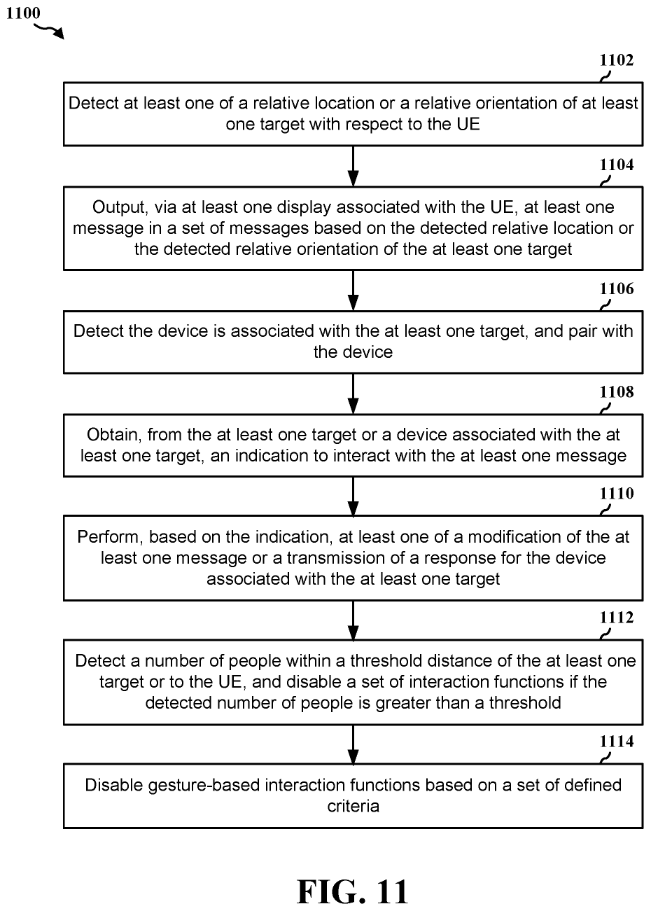

FIG. 11 is a flowchart 1100 of a method of wireless communication at a user equipment (UE). The method may be performed by a UE (e.g., the UE 104, 404; the vehicle 502; the advertisement vehicle 602; the apparatus 1204). The method may configure the UE to enable interactions between displayed advertisements and users based on relative positioning measurements and gesture recognition of the users.

At 1102, the UE may detect at least one of a relative location or a relative orientation of at least one target with respect to the UE, such as described in connection with FIGS. 6, 7A, 7B, 8, and 9. For example, as discussed in connection with 614 of FIG. 6, the advertisement vehicle 602 may detect that a target user 604 is in its proximity (e.g., within a threshold/defined distance of the advertisement vehicle 602). Based on the detection of the target user 604, the advertisement vehicle 602 may also determine/calculate the location, the relative location, and/or the relative orientation of the target user 604. The detection of at least one of the relative location or the relative orientation of at least one target with respect to the UE may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

At 1104, the UE may output, via at least one display associated with the UE, at least one message in a set of messages based on the detected relative location or the detected relative orientation of the at least one target, such as described in connection with FIGS. 6, 7A, 7B, 8, and 9. For example, as discussed in connection with 616 and 618 of FIG. 6, utilizing the (relative) location/orientation information of the target user 604, the advertisement vehicle 602 may select at least one of its displays to show/output one or more advertisements to the target user 604. The output of the at least one message in the set of messages may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, the set of messages may include a set of advertisements, and the at least one message may be at least one advertisement.

At 1108, the UE may obtain, from the at least one target or a device associated with the at least one target, an indication to interact with the at least one message, such as described in connection with FIGS. 7A, 7B, 8, and 9. For example, as discussed in connection with FIGS. 7A and 7B, the advertisement vehicle 602 may have the capability to enable the target user 604 to interact with the advertisement vehicle 602, such as requesting for additional information related to the advertisement displayed by the advertisement vehicle 602. For example, as shown at 706 in FIG. 7A, the advertisement may indicate to the target user 604 to approach the advertisement vehicle 602 or the second display 612 for more information. Then, if the advertisement vehicle 602 detects that the target user 604 approaches the advertisement vehicle 602 (e.g., based on using the set of cameras 606 and/or the set of the RF sensors 608, etc.), the advertisement vehicle 602 may display additional information related to the displayed advertisement (e.g., menu and discounts at Café XYZ, etc.). The obtainment of the indication may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, to obtain, from the at least one target or the device associated with the at least one target, the indication to interact with the at least one message, the UE may be configured to receive a first input from the device associated with the at least one target, receive a second input from one or more components associated with the at least one display, and/or receive a third input based on a gesture performed by the at least one target using at least one sensor or at least one camera. In some implementations, the at least one message may include a set of gestures that can be used for interacting with the at least one message.

In another example, to obtain, from the at least one target, the indication to interact with the at least one message, the UE may be configured to receive, from the at least one target, a request for additional information related to the at least one message. In some implementations, to perform the modification of the at least one message, the UE may be configured to adapt the at least one display to display the addition information requested by the at least one target. In some implementations, to perform the transmission of the response, the UE may be configured to transmit, to the device associated with the at least one target, an acknowledgement of the request.

At 1110, the UE may perform, based on the indication, at least one of a modification of the at least one message or a transmission of a response for the device associated with the at least one target, such as described in connection with FIGS. 7A, 7B, 8, and 9. For example, as discussed in connection with FIGS. 7A and 7B, in response to the input(s) or request(s) from the user (e.g., via the virtual/physical buttons, based on gesture recognitions, etc.), the advertisement vehicle 602 may adapt the display to show the additional/requested information, or an acknowledgment of the requested information being provided to the device associated with the user. The modification of the at least one message or the transmission of the response may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In one example, as shown at 1106, the UE may detect the device is associated with the at least one target, and pair with the device, such as described in connection with FIGS. 7A, 7B, 8, and 9. For example, as discussed in connection with 710 of FIG. 7B, if the advertisement vehicle 602 has the capability to pair with a device (e.g., a mobile phone) held by the target user 604, such as based on a pairing mechanism (e.g., Bluetooth, Wi-Fi, etc.), the target user 604 may also be able to interact with the advertisement displayed by the second display 612 using the virtual/physical buttons on the target user's device. The detection of the device and/or the pairing of the device may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12. In some implementations, to obtain, from the at least one target, the indication to interact with the at least one message, the UE may be configured to obtain, from the paired device, a set of inputs to interact with the at least one message. In some implementations, to detect the device associated with the at least one target, the UE may be configured to estimate a first position of the at least one target using at least one of a sensor or a camera, estimate a second position of the device based on a set of radio frequency (RF) measurements, and determine that the device is associated with the at least one target based on the estimated first position of the at least one target being within a threshold distance of the second position of the device.

In another example, to obtain the indication to interact with the at least one message, the UE may be configured to obtain a first request for a direction to a business associated with the at least one message, obtain a second request for additional information related to the at least one message, and/or obtain a third request for a coupon related to the at least one message.

In another example, the UE may detect a speed of the UE or a relative velocity between the UE and the at least one target, where to output, via the at least one display associated with the UE, the at least one message, the UE may be configured to display the at least one message using a set of static images if the detected speed of the UE or the relative velocity between the UE and the at least one target is greater than a threshold.

In another example, as shown at 1112, the UE may detect a number of people within a threshold distance of the at least one target or to the UE, and disable a set of interaction functions if the detected number of people is greater than a threshold, such as described in connection with FIGS. 8, and 9. For example, the advertisement vehicle 602 may also be configured to enabling/disabling the interaction functions based on the density of outer users (in certain region(s)). In other words, the density of outer users may serve as a criterion for enabling/disabling interactions. For example, when the advertisement vehicle 602 detects that pedestrians in a region is beyond a density threshold (e.g., the number of pedestrians detected within an area/FOV exceeds a defined number), the advertisement vehicle 602 may be configured to disable gesture-based interactions in the interest of driver safety (e.g., simultaneous gestures from multiple pedestrians may be distracting to drivers). The detection of the number of people and/or the disablement of the set of interaction functions may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In another example, as shown at 1114, the UE may disable gesture-based interaction functions based on a set of defined criteria, such as described in connection with FIGS. 8 and 9. For example, the advertisement vehicle 602 may also disable gesture-based interactions for outer users in certain regions with respect to the vehicle. For instance, a pedestrian located in the FOV of the driver of the advertisement vehicle 602 may not be able to use gesture-based interactions. In another example, interaction function(s) for outer users may be disabled when the advertisement vehicle 602 and/or the outer users are located in flagged regions, such as when the outer users are detected to be on crosswalks/crossing the streets, or when the advertisement vehicle 602 is in a school zone (to avoid causing distractions to students/kids), etc. The disablement of the gesture-based interaction functions may be performed by, e.g., the interactive advertisement component 198, the camera 1232, the one or more sensors 1218, the transceiver(s) 1222, the cellular baseband processor(s) 1224, and/or the application processor(s) 1206 of the apparatus 1204 in FIG. 12.

In another example, the UE may select the at least one message in the set of messages based on at least one of the detected relative location or the detected relative orientation of the at least one target.

In another example, the UE may select a set of parameters for outputting the at least one message based on at least one of the detected relative location or the detected relative orientation of the at least one target, where to output the at least one message, the UE may be configured to output the at least one message based on the set of parameters. In some implementations, the set of parameters for displaying the at least one message includes at least one of: a display size for the at least one message, an amount of information to be displayed for the at least one message, a font size for the at least one message, a set of colors to be used for the at least one message, a display brightness for the at least one message, or a display angle for the at least one message. In some implementations, to select the set of parameters for displaying the at least one message based on at least one of the detected relative location or the detected relative orientation of the at least one target, the UE may be configured to select the set of parameters for displaying the at least one message based on at least one of: a distance of the at least one target from the UE, a movement of the at least one target with respect to the UE, a height of the at least one target with respect to the UE, or a motion state associated with the UE.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an ultrawide band (UWB) module 1238, an SPS module 1216 (e.g., GNSS module), smart glass(es) 1240, one or more sensors 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the UWB module 1238, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the interactive advertisement component 198 may be configured to detect at least one of a relative location or a relative orientation of at least one target with respect to the UE. The interactive advertisement component 198 may also be configured to output, via at least one display associated with the UE, at least one message in a set of messages based on the detected relative location or the detected relative orientation of the at least one target. The interactive advertisement component 198 may also be configured to obtain, from the at least one target or a device associated with the at least one target, an indication to interact with the at least one message. The interactive advertisement component 198 may also be configured to perform, based on the indication, at least one of a modification of the at least one message or a transmission of a response for the device associated with the at least one target. The interactive advertisement component 198 may be within the cellular baseband processor(s) 1224, the application processor(s) 1206, or both the cellular baseband processor(s) 1224 and the application processor(s) 1206. The interactive advertisement component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for detecting at least one of a relative location or a relative orientation of at least one target with respect to the UE. The apparatus 1204 may further include means for outputting, via at least one display associated with the UE, at least one message in a set of messages based on the detected relative location or the detected relative orientation of the at least one target. The apparatus 1204 may further include means for obtaining, from the at least one target or a device associated with the at least one target, an indication to interact with the at least one message. The apparatus 1204 may further include means for performing, based on the indication, at least one of a modification of the at least one message or a transmission of a response for the device associated with the at least one target.

In one configuration, the set of messages may include a set of advertisements, and the at least one message may be at least one advertisement.

In another configuration, the means for obtaining, from the at least one target or the device associated with the at least one target, the indication to interact with the at least one message may include configuring the apparatus 1204 to receive a first input from the device associated with the at least one target, receive a second input from one or more components associated with the at least one display, and/or receive a third input based on a gesture performed by the at least one target using at least one sensor or at least one camera. In some implementations, the at least one message may include a set of gestures that can be used for interacting with the at least one message.

In another configuration, to obtain, from the at least one target, the indication to interact with the at least one message may include configuring the apparatus 1204 to receive, from the at least one target, a request for additional information related to the at least one message. In some implementations, the means for performing the modification of the at least one message may include configuring the apparatus 1204 to adapt the at least one display to display the addition information requested by the at least one target. In some implementations, the means for performing the transmission of the response may include configuring the apparatus 1204 to transmit, to the device associated with the at least one target, an acknowledgement of the request.

In another configuration, the apparatus 1204 may further include means for detecting the device is associated with the at least one target, and means for pairing with the device. In some implementations, the means for obtaining, from the at least one target, the indication to interact with the at least one message may include configuring the apparatus 1204 to obtain, from the paired device, a set of inputs to interact with the at least one message. In some implementations, the means for detecting the device associated with the at least one target may include configuring the apparatus 1204 to estimate a first position of the at least one target using at least one of a sensor or a camera, estimate a second position of the device based on a set of radio frequency measurements, and determine that the device is associated with the at least one target based on the estimated first position of the at least one target being within a threshold distance of the second position of the device.

In another configuration, the means for obtaining the indication to interact with the at least one message may include configuring the apparatus 1204 to obtain a first request for a direction to a business associated with the at least one message, obtain a second request for additional information related to the at least one message, and/or obtain a third request for a coupon related to the at least one message.

In another configuration, the apparatus 1204 may further include means for detecting a speed of the apparatus 1204 or a relative velocity between the apparatus 1204 and the at least one target, where the means for outputting, via the at least one display associated with the apparatus 1204, the at least one message may include configuring the apparatus 1204 to display the at least one message using a set of static images if the detected speed of the apparatus 1204 or the relative velocity between the apparatus 1204 and the at least one target is greater than a threshold.

In another configuration, the apparatus 1204 may further include means for detecting a number of people within a threshold distance of the at least one target or to the apparatus 1204, and means for disabling a set of interaction functions if the detected number of people is greater than a threshold.

In another configuration, the apparatus 1204 may further include means for disabling gesture-based interaction functions based on a set of defined criteria.

In another configuration, the apparatus 1204 may further include means for selecting the at least one message in the set of messages based on at least one of the detected relative location or the detected relative orientation of the at least one target.

In another configuration, the apparatus 1204 may further include means for selecting a set of parameters for outputting the at least one message based on at least one of the detected relative location or the detected relative orientation of the at least one target, where the means for outputting the at least one message may include configuring the apparatus 1204 to output the at least one message based on the set of parameters. In some implementations, the set of parameters for displaying the at least one message includes at least one of: a display size for the at least one message, an amount of information to be displayed for the at least one message, a font size for the at least one message, a set of colors to be used for the at least one message, a display brightness for the at least one message, or a display angle for the at least one message. In some implementations, the means for selecting the set of parameters for displaying the at least one message based on at least one of the detected relative location or the detected relative orientation of the at least one target may include configuring the apparatus 1204 to select the set of parameters for displaying the at least one message based on at least one of: a distance of the at least one target from the apparatus 1204, a movement of the at least one target with respect to the apparatus 1204, a height of the at least one target with respect to the apparatus 1204, or a motion state associated with the apparatus 1204.

The means may be the interactive advertisement component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: detecting at least one of a relative location or a relative orientation of at least one target with respect to the UE; outputting, via at least one display associated with the UE, at least one message in a set of messages based on the detected relative location or the detected relative orientation of the at least one target; obtaining, from the at least one target or a device associated with the at least one target, an indication to interact with the at least one message; and performing, based on the indication, at least one of a modification of the at least one message or a transmission of a response for the device associated with the at least one target.

Aspect 2 is the method of aspect 1, wherein obtaining, from the at least one target or the device associated with the at least one target, the indication to interact with the at least one message comprises at least one of: receiving a first input from the device associated with the at least one target, receiving a second input from one or more components associated with the at least one display, or receiving a third input based on a gesture performed by the at least one target using at least one sensor or at least one camera.

Aspect 3 is the method of aspect 1 or aspect 2, wherein the at least one message includes a set of gestures that can be used for interacting with the at least one message.

Aspect 4 is the method of any of aspects 1 to 3, wherein obtaining, from the at least one target, the indication to interact with the at least one message comprises: receiving, from the at least one target, a request for additional information related to the at least one message.

Aspect 5 is the method of any of aspects 1 to 4, wherein performing the modification of the at least one message comprises: adapting the at least one display to display the addition information requested by the at least one target.

Aspect 6 is the method of any of aspects 1 to 5, wherein performing the transmission of the response comprises: transmitting, to the device associated with the at least one target, an acknowledgement of the request.

Aspect 7 is the method of any of aspects 1 to 6, further comprising: detecting the device is associated with the at least one target; and pairing with the device, wherein obtaining, from the at least one target, the indication to interact with the at least one message comprises obtaining, from the paired device, a set of inputs to interact with the at least one message.

Aspect 8 is the method of any of aspects 1 to 7, wherein detecting the device associated with the at least one target comprises: estimating a first position of the at least one target using at least one of a sensor or a camera; estimating a second position of the device based on a set of radio frequency (RF) measurements; and determining that the device is associated with the at least one target based on the estimated first position of the at least one target being within a threshold distance of the second position of the device.

Aspect 9 is the method of any of aspects 1 to 8, wherein obtaining the indication to interact with the at least one message comprises at least one of: obtaining a first request for a direction to a business associated with the at least one message, obtaining a second request for additional information related to the at least one message, or obtaining a third request for a coupon related to the at least one message.

Aspect 10 is the method of any of aspects 1 to 9, further comprising detecting a speed of the UE or a relative velocity between the UE and the at least one target, wherein outputting, via the at least one display associated with the UE, the at least one message comprises: displaying the at least one message using a set of static images if the detected speed of the UE or the relative velocity between the UE and the at least one target is greater than a threshold.

Aspect 11 is the method of any of aspects 1 to 10, further comprising: disabling a set of interaction functions if the detected speed of the UE or the relative velocity between the UE and the at least one target is greater than the threshold.

Aspect 12 is the method of any of aspects 1 to 11, further comprising: detecting a number of people within a threshold distance of the at least one target or to the UE; and disabling a set of interaction functions if the detected number of people is greater than a threshold.

Aspect 13 is the method of any of aspects 1 to 12, further comprising: disabling gesture-based interaction functions based on a set of defined criteria.

Aspect 14 is the method of any of aspects 1 to 13, where the set of messages comprises a set of advertisements, and where the at least one message is at least one advertisement.

Aspect 15 is the method of any of aspects 1 to 14, further comprising: electing the at least one message in the set of messages based on at least one of the detected relative location or the detected relative orientation of the at least one target.

Aspect 16 is the method of any of aspects 1 to 15, further comprising: selecting a set of parameters for outputting the at least one message based on at least one of the detected relative location or the detected relative orientation of the at least one target, wherein outputting the at least one message comprises outputting the at least one message based on the set of parameters.

Aspect 17 is the method of any of aspects 1 to 16, wherein the set of parameters for displaying the at least one message includes at least one of: a display size for the at least one message, an amount of information to be displayed for the at least one message, a font size for the at least one message, a set of colors to be used for the at least one message, a display brightness for the at least one message, or a display angle for the at least one message.

Aspect 18 is the method of any of aspects 1 to 17, wherein selecting the set of parameters for displaying the at least one message based on at least one of the detected relative location or the detected relative orientation of the at least one target comprises: selecting the set of parameters for displaying the at least one message based on at least one of: a distance of the at least one target from the UE, a movement of the at least one target with respect to the UE, a height of the at least one target with respect to the UE, or a motion state associated with the UE.

Aspect 19 is the method of any of aspects 1 to 18, wherein the UE is a vehicle, an on-board unit (OBU), a device running an advertisement application, or a display system.

Aspect 20 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 19.

Aspect 21 is the apparatus of aspect 20, further including at least one transceiver coupled to the at least one processor.

Aspect 22 is an apparatus for wireless communication at a user equipment (UE), including means for implementing any of aspects 1 to 19.

Aspect 23 is a computer-readable medium (e.g., a non-transitory computer-readable medium) storing computer executable code, where the code when executed by a processor causes the processor to implement any of aspects 1 to 19.

What is claimed is:

1. An apparatus for wireless communication at a user equipment (UE), comprising:
at least one memory; and
at least one processor coupled to the at least one memory, the at least one processor, individually or in any combination, is configured to:
detect at least one of a relative location or a relative orientation of at least one target with respect to the UE;
output, via at least one display associated with the UE, at least one message in a set of messages based on the detected relative location or the detected relative orientation of the at least one target;
obtain, from the at least one target or a device associated with the at least one target, an indication to interact with the at least one message; and
perform, based on the indication, at least one of a modification of the at least one message or a transmission of a response for the device associated with the at least one target.

2. The apparatus of claim 1, wherein to obtain, from the at least one target or the device associated with the at least one target, the indication to interact with the at least one message, the at least one processor, individually or in any combination, is configured to:
receive a first input from the device associated with the at least one target,
receive a second input from one or more components associated with the at least one display, or
receive a third input based on a gesture performed by the at least one target using at least one sensor or at least one camera.

3. The apparatus of claim 2, wherein the at least one message includes a set of gestures that can be used for interacting with the at least one message.

4. The apparatus of claim 1, wherein to obtain, from the at least one target, the indication to interact with the at least one message, the at least one processor, individually or in any combination, is configured to:
receive, from the at least one target, a request for additional information related to the at least one message.

5. The apparatus of claim 4, wherein to perform the modification of the at least one message, the at least one processor, individually or in any combination, is configured to:
adapt the at least one display to display the addition information requested by the at least one target.

6. The apparatus of claim 4, wherein to perform the transmission of the response, the at least one processor, individually or in any combination, is configured to:
transmit, to the device associated with the at least one target, an acknowledgement of the request.

7. The apparatus of claim 1, wherein the at least one processor, individually or in any combination, is further configured to:
detect the device is associated with the at least one target; and
pair with the device, wherein to obtain, from the at least one target, the indication to interact with the at least one message, the at least one processor, individually or in any combination, is configured to obtain, from the paired device, a set of inputs to interact with the at least one message.

8. The apparatus of claim 7, wherein to detect the device associated with the at least one target, the at least one processor, individually or in any combination, is configured to:
estimate a first position of the at least one target using at least one of a sensor or a camera;
estimate a second position of the device based on a set of radio frequency (RF) measurements; and
determine that the device is associated with the at least one target based on the estimated first position of the at least one target being within a threshold distance of the second position of the device.

9. The apparatus of claim 1, wherein to obtain the indication to interact with the at least one message, the at least one processor, individually or in any combination, is configured to:
obtain a first request for a direction to a business associated with the at least one message,
obtain a second request for additional information related to the at least one message, or
obtain a third request for a coupon related to the at least one message.

10. The apparatus of claim 1, wherein the at least one processor, individually or in any combination, is further configured to detect a speed of the UE or a relative velocity between the UE and the at least one target, wherein to output, via the at least one display associated with the UE, the at least one message, the at least one processor, individually or in any combination, is configured to:
display the at least one message using a set of static images if the detected speed of the UE or the relative velocity between the UE and the at least one target is greater than a threshold.

11. The apparatus of claim 10, wherein the at least one processor, individually or in any combination, is further configured to:
disable a set of interaction functions if the detected speed of the UE or the relative velocity between the UE and the at least one target is greater than the threshold.

12. The apparatus of claim 1, wherein the at least one processor, individually or in any combination, is further configured to:
detect a number of people within a threshold distance of the at least one target or to the UE; and
disable a set of interaction functions if the detected number of people is greater than a threshold.

13. The apparatus of claim 1, wherein the at least one processor, individually or in any combination, is further configured to:
disable gesture-based interaction functions based on a set of defined criteria.

14. The apparatus of claim 1, further comprising at least one transceiver coupled to the at least one processor, wherein to obtain the indication, the at least one processor, individually or in any combination, is configured to obtain the indication via the at least one transceiver, wherein the set of messages comprises a set of advertisements, and wherein the at least one message is at least one advertisement.

15. A method of wireless communication at a user equipment (UE), comprising:
detecting at least one of a relative location or a relative orientation of at least one target with respect to the UE;
outputting, via at least one display associated with the UE, at least one message in a set of messages based on the detected relative location or the detected relative orientation of the at least one target;
obtaining, from the at least one target or a device associated with the at least one target, an indication to interact with the at least one message; and
performing, based on the indication, at least one of a modification of the at least one message or a transmission of a response for the device associated with the at least one target.

16. The method of claim 15, wherein obtaining, from the at least one target or the device associated with the at least one target, the indication to interact with the at least one message comprises at least one of:
receiving a first input from the device associated with the at least one target,
receiving a second input from one or more components associated with the at least one display, or
receiving a third input based on a gesture performed by the at least one target using at least one sensor or at least one camera.

17. The method of claim 15, further comprising:
detecting the device is associated with the at least one target; and
pairing with the device, wherein obtaining, from the at least one target, the indication to interact with the at least one message comprises obtaining, from the paired device, a set of inputs to interact with the at least one message.

18. The method of claim 15, further comprising detecting a speed of the UE or a relative velocity between the UE and the at least one target, wherein outputting, via the at least one display associated with the UE, the at least one message comprises:
displaying the at least one message using a set of static images if the detected speed of the UE or the relative velocity between the UE and the at least one target is greater than a threshold.

19. The method of claim 15, further comprising:
detecting a number of people within a threshold distance of the at least one target or to the UE; and
disabling a set of interaction functions if the detected number of people is greater than a threshold.

20. A computer-readable medium storing computer executable code at a user equipment (UE), the code when executed by at least one processor causes the at least one processor to:
detect at least one of a relative location or a relative orientation of at least one target with respect to the UE;
output, via at least one display associated with the UE, at least one message in a set of messages based on the detected relative location or the detected relative orientation of the at least one target;
obtain, from the at least one target or a device associated with the at least one target, an indication to interact with the at least one message; and
perform, based on the indication, at least one of a modification of the at least one message or a transmission of a response for the device associated with the at least one target.
